(19) United States
(12) Patent Application Publication
(10) Pub. No.: US 2005/0067791 A1
(43) Pub. Date: Mar. 31, 2005

(54) Sealing element

(75) Inventors: Stefan Bock, Grossostheim/Ringheim (DE); Thomas Rosch, Linsengericht (DE)

Correspondence Address: BURNS DOANE SWECKER & MATHIS L L P, POST OFFICE BOX 1404, ALEXANDRIA, VA, 22313-1404, US

(73) Assignees: Veritas AG, Gelnhausen (DE); ElringKlinger AG, Dettingen/Erms (DE)

(21) Appl. No.: 10/919,255

(22) Filed: Aug. 17, 2004

(30) Foreign Application Priority Data
Aug. 28, 2003 (DE) 103 39 718.3

(51) Int. Cl. F16J 15/16

(52) U.S. Cl. 277/500

(57) ABSTRACT

The present invention refers to a sealing element, preferably for sealing quick couplers of fuel lines, particularly in automotive vehicles, comprising a supporting section which is made at least in part from an elastic material, and a sealing section which is made from a material differing from the elastic material, the sealing element being provided on its circumference with at least one contact surface and at least one sealing surface. Such a sealing element can thereby be produced in an installation-friendly and inexpensive way in that according to the invention at least one contact surface is formed by the supporting section and at least one sealing surface by the sealing section.

The present invention relates to a sealing element, preferably for sealing quick couplers of fuel lines, particularly in automotive vehicles, comprising a supporting section which is made at least in part from an elastic material, and a sealing section which is made from a material differing from the elastic material, the sealing element being provided on its circumference with at least one contact surface and at least one sealing surface.

Such sealing elements are known from the prior art.

EP 0 817 929 shows a sealing system for refrigerators, the sealing system consisting of a sealing ring of PTFE and a pretension ring consisting at least in part of silicone rubber, polyurethane or tetrafluoroethylene. The pretension ring has an elastic silicone rubber core and is surrounded by a PTFE envelope. The pretension ring is to produce enough pretension for the sealing ring.

In the car sector, fuel lines are normally provided with quick couplers to gain time during installation or in case of repair. The seals have the function to prevent liquid or gaseous leakage of hydrocarbons for the whole service life. Conventional seals consist of O-ring systems, for instance, of a Viton (FPM) and a silicone O-ring. As a rule, the one ring has a supporting function for producing a bias between the elements to be sealed, and the other ring has a sealing function to prevent leakage.

Due to tightened emission guidelines, today's O-ring systems are no longer adequate because they are not sufficiently permeation-tight—not even in the standard temperature range. When temperatures are changing, the FPM O-ring allows slight leakage which is retained by the silicone O-ring. During subsequent heating, fuel can still increasingly escape in gaseous form. Spring-supported seals of PTFE can replace O-ring solutions in many applications, but they are expensive and require an improved surface quality of the sealing surfaces.

It is therefore the object of the present invention to improve a sealing element of the type mentioned at the outset in such a way that assembly in the installation room is facilitated on the one hand and the production and assembly costs are reduced on the other hand without the need for changes in today's production of the housing and shaft to be sealed.

According to the invention this object is achieved by a sealing element which is characterized in that at least one contact surface is formed by the supporting section and at least one sealing surface by the sealing section.

The sealing element of the invention fulfills supporting function and sealing function at the same time because it is provided on its surface with two corresponding surface sections of different materials. The elastic supporting material uniformly distributes the pressure over the contact surface, whereby the surface roughness of the contact surface is compensated and also tightly sealed. The sealing section which is made from a material differing from the elastic material of the supporting section produces a high contact pressure on the sealing surface and a tight sealing effect. This solution is simpler than an O-ring system of the above-described type and, nevertheless, offers comparable emission values. In particular, the assembly can be simplified and the constructional space can be reduced by the solution of the invention. In comparison with the known O-ring systems the use of a second element is thus not needed. This reduces the costs for material and installation at the same time.

In comparison with the known O-ring system, no improved surface quality of the complementary surface is needed, and thus also no change in today's manufacture of the housing and shaft to be sealed.

In comparison with spring arrangements, the sealing element of the invention shows a long-time stability and is only subject to a negligible minor permanent deformation under the sealing pressure.

In a preferred embodiment, one contact surface and one sealing surface are positioned at opposite sides of the sealing element. Thus the sealing effect is particularly high when on the sealing surface a compressive force is introduced from a component to be sealed and the sealing element can be supported on the opposite side. A very high contact pressure can thereby be built up as well.

An embodiment turns out to be of particular advantage, wherein the supporting section is firmly connected to the sealing section. For instance, the sealing element forms a very compact unit, and the risk is reduced that supporting section and sealing section detach from one another under high load.

In an advantageous development of the invention, the supporting section is matingly connected to the sealing section. Under the contact pressure exerted by the components to be sealed on the sealing element, the two sections are pressed together. Thus the sealing section remains movable relative to the supporting section and moves itself into an optimum position in the case of a suitable arrangement, e.g. when the two sections are positioned at opposite sides of the sealing element, thereby providing an ideal seal, for instance also when transverse forces are introduced.

In a particularly preferred embodiment, the sealing element is reinforced by a reinforcing means. For instance, an even greater contact pressure can be built up on the sealing surface, which further enhances the sealing effect.

A particularly suitable reinforcing means is here a spring means which comprises at least one spring. A spring can excellently be integrated into the sealing element of the invention.

It is here of particular advantage when the spring is positioned at least sectionwise within the supporting section. Since said section is made from an elastic material, the spring characteristics are here felt in an advantageous way. For instance, the supporting effect of the supporting section is particularly high especially under high compressive forces.

It has turned out to be advantageous when the spring is a bent spring strip. A spring strip can be employed in a particularly flexible and multiple way and it can be formed accordingly for developing the spring force under compressive load.

It has turned out to be of particular advantage when the spring has a substantially U-shaped profile. The spring curvature is excellently suited for supporting the sealing side at which the compressive force is normally introduced into the sealing element. The opposite opened side is suited particularly well as a contact side.

It has turned out to be advantageous when the sealing section is made at least sectionwise from fluorine-containing material. Fluorine has a barrier effect with respect to hydrocarbons, so that a corresponding sealing element is particularly well suited for use in fuel lines in the car sector.

It is also advantageous when the sealing section is made from a plastic material because plastic components can normally be produced at low costs. Moreover, the shape for plastic products is in general relatively simple.

It has been found to be of particular advantage to produce the sealing section from a polymer because this material can be processed easily and shows a particularly high dimensional stability.

Among the polymer materials, polyethylene turns out to be particularly suited because fluorine-containing components can easily be incorporated into the plastic matrix thereof.

Furthermore, polytetrafluoroethylene (PTFE), especially TFM, is particularly well suited for producing the sealing section because of its barrier effect with respect to hydrocarbons.

Moreover, it may turn out to be advantageous when the supporting section is made from an elastomer material. The soft elastomer can easily compensate the surface roughness of the complementary surface and has a high sealing effect.

For improving the pressure distribution over sealing surface and contact surface, it may be of advantage that the outer surface of the sealing element comprises at least one substantially arcuate section. Under compressive load a high surface pressure can be achieved in the area of the arcuate section and thus a particularly high sealing effect, especially in the case of pressure differences at both sides of the seal.

Moreover, it may also turn out to be advantageous when the sealing surface is here substantially positioned inside the arcuate section. For instance, the arcuate section is particularly well suited to seal the sealing element relative to another component, and the other, preferably planar, section is particularly suited to support the sealing element relative to another component.

In an advantageous development of the invention, the sealing section forms a sealing lip, whereby a particularly high sealing effect can be achieved.

In a preferred embodiment, the sealing element forms a sealing ring. As a result, it can specifically be used for sealing connections having a substantially circular cross-section.

For reinforcing the above-mentioned sealing ring, it turns also out to be advantageous when the spring is a spring ring and is arranged coaxial to the sealing ring.

It may turn out to be advantageous that the contact surface is formed at an axial end of the sealing ring substantially perpendicular to the axis of the sealing ring. As a result, the sealing ring can be supported in axial direction in a better way with respect to a planar support surface of a connection member.

To be able to transmit the axial compressive forces in an improved way to a further connection member, it turns out to be advantageous when the sealing surface is formed at another axial end of the sealing element with respect to the planar contact surface.

To receive axial compressive forces and thus to produce a high surface pressure on the sealing surface, it is of particular advantage when the front side of the sealing element is the sealing side at the same time. The sealing effect is thereby improved.

To be able to center the sealing element, it turns out to be advantageous that the sealing ring comprises at least one contact surface in radial direction. This facilitates, for instance, the assembly of a quick coupler.

Specific size ratios also turn out to be advantageous for achieving a particularly high sealing effect: Normally, when two components are sealed, a contact surface is obtained between the sealing section and the component to be sealed. Said contact surface is normally small, but there prevails a high surface pressure as a rule. The function of the supporting section consists in supporting the sealing element and in securing said element in a very stable way. If, by comparison, the elastic supporting section is much larger than the sealing section, this will improve the distribution of the compressive forces over the elastic supporting material and thus the sealing characteristic of the sealing element. It may here turn out to be advantageous when the sealing section, on the whole, does not occupy more than 25% of the cross-sectional surface of the sealing element.

In practice, it may turn out to be of advantage when the inner diameter of a sealing ring according to the invention is preferably about 80-95%, preferably 90%, of the outer diameter.

In an advantageous development of the invention, the sealing surface preferably covers 60-90%, preferably 75%, of the arc length of the arcuate section of the sealing element. The resulting residual surface segments of the supporting section are particularly well suited for the mounting of centering surfaces.

Furthermore, it may turn out to be very advantageous when the surfaces of the supporting section and of the sealing section are flush with one another. This reduces, on the one hand, the risk that the supporting and sealing sections might detach from one another. On the other hand, the sealing function of the sealing element is ensured even if contact with a component to be sealed exists exactly at one of the transition points.

In a preferred manufacturing method, the supporting section and the sealing section are integrally formed on one another. This means that either the supporting section is integrally formed on the sealing section or the sealing section on the supporting section. The two sections can thereby be connected in an easy, permanent and firm way, so that the transitions on the surface of the two sections are flush.

A manufacturing method of particular advantage turns out to be the injection method insofar as the supporting section is injected into the sealing section. The sealing element of the invention should preferably be made from plastic materials. These can very easily be processed in the softened state by injection. In addition, this permits a component construction, wherein the sealing element is first manufactured and then placed in a mold in the cured state. In a further operation the supporting section, which according to the invention consists at least in part of an elastic material, is then injected at the back side into the existing mold. As a result, the two sections can be connected in a permanent and firm way to one another, so that the two sections are flush with one another.

The invention as well as its use and function shall now be explained in more detail with reference to an embodiment.

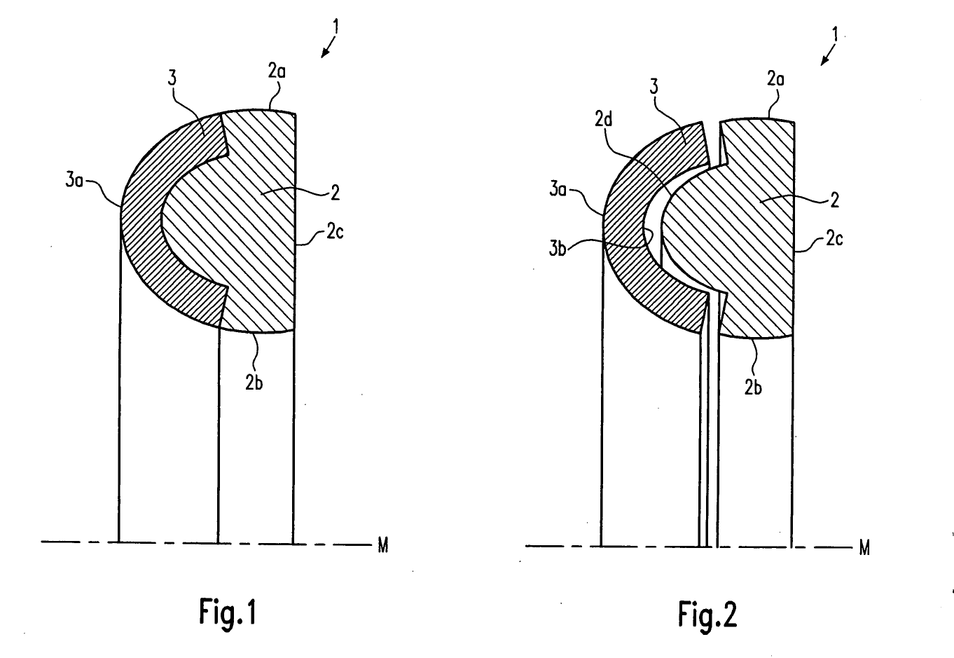

FIG. 1 is a cross-sectional view of a sealing ring of the invention, supporting section and sealing section being firmly connected.

FIG. 2 is a cross-sectional view of a sealing ring of the invention, supporting section and sealing section being matingly connected.

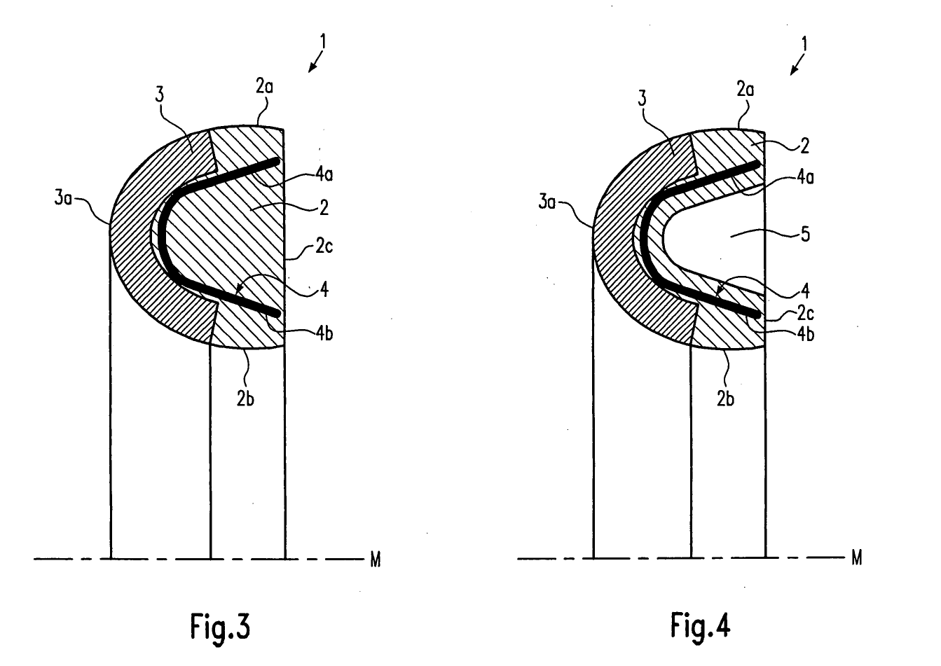

FIG. 3 is a cross-sectional view of a sealing ring of the invention with spring reinforcement.

FIG. 4 is a cross-sectional view of a sealing ring of the invention with spring reinforcement and a free space on the supporting section due to the manufacturing process.

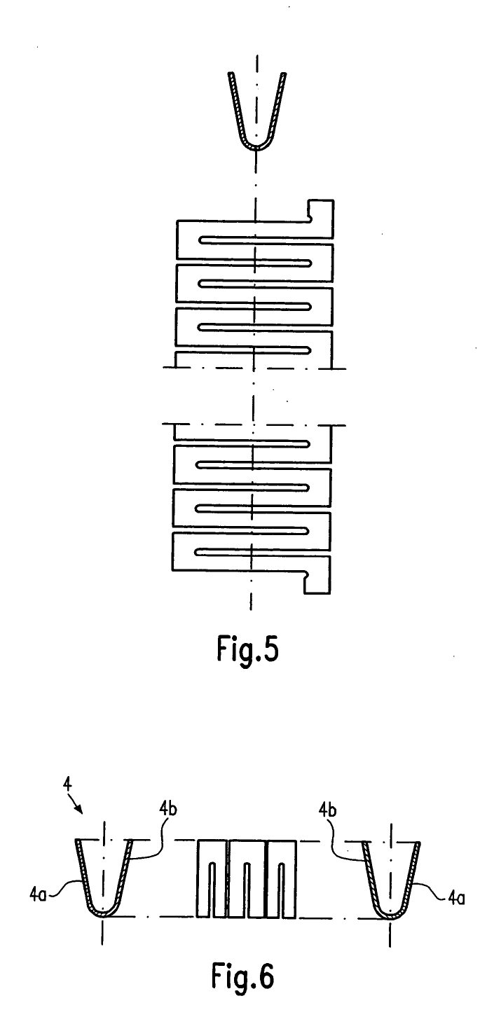

FIG. 5 is a view of a spring strip in the undeformed state and a cross-sectional view in the deformed state (U-profile).

FIG. 6 is a view of a spring ring in cross section.

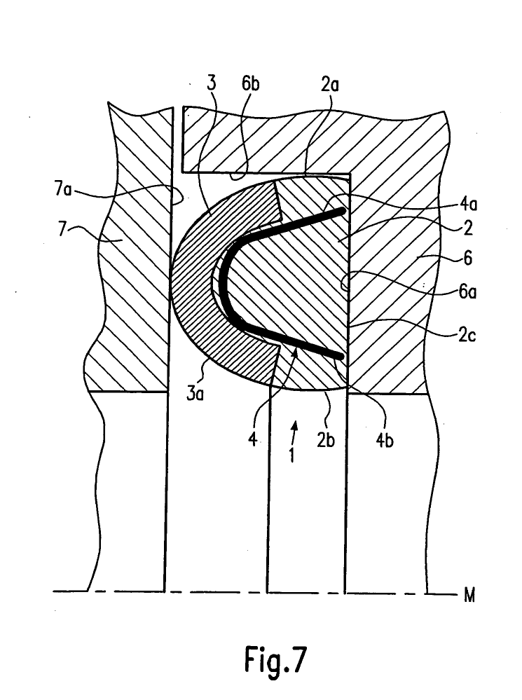

FIG. 7 is a cross-sectional view of a sealing ring of the invention with spring reinforcement between two components to be axially sealed.

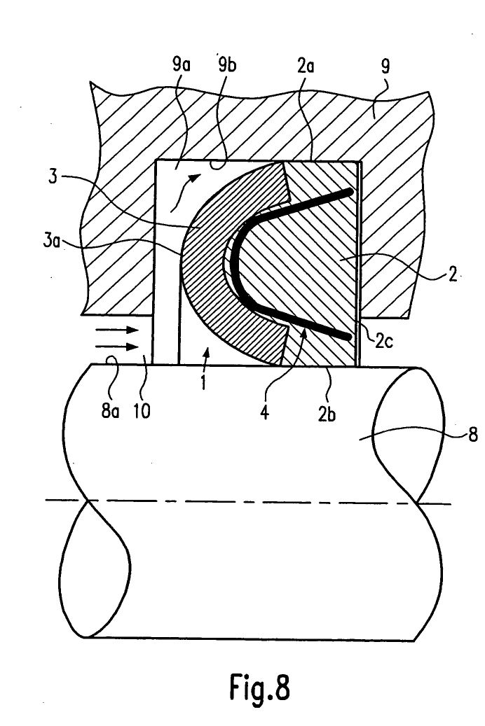

FIG. 8 is a cross-sectional view of a sealing ring of the invention with spring reinforcement between two components to be radially sealed.

Under the described aspect of the invention, the sealing element 1 is a sealing ring created by rotation of the cross section sketched in FIG. 1 about axis A.

In the cross section of FIG. 1, the sealing element 1 has a supporting section 2 and a sealing section 3.

The surface of the sealing element of the invention shall now be described in more detail: For better understanding the surface of the sealing element is divided into segments in FIG. 1. The supporting section 2 forms the contact surfaces 2a, 2b and 2c which are intended for contact with components to be sealed. The contact surfaces 2a and 2b are intended for contact of the sealing ring in radial direction; the contact surface 2c is intended for contact in axial direction. The sealing section 3 rests on the outside of the sealing element 1 and forms sealing surface 3a. The surfaces of the supporting section 2a, 2b and of the sealing section 3a are flush with one another.

The one axial end side of the sealing ring at reference numeral 3a will now be designated as the front side, and the other opposite axial end side of the sealing element 1 at reference numeral 2c as the contact side.

In the cross section in FIG. 1, the sealing element 1 is provided on its surface with a straight section (segment 2c) and an arcuate section. The arcuate section extends over the surface segments 2a, 2b and 3a.

The sealing section 3 is centrally located on the front side of the sealing ring within the arcuate section. At the same time, said front side is the sealing side from which fuel is introduced from a component to be sealed.

In the area of the arcuate section 2a, 2b and 3a the contour of the sealing element 1 substantially follows the shape of a parabola. The sealing section 3 in its arcuate extension preferably has a constant thickness and is therefore substantially in the form of a U-profile. In the illustrated embodiment, sealing surface 3a approximately covers 75% of the arc length of the arcuate section. The adjoining surface sections 2a and 2b are particularly suited as contact or centering surfaces in radial direction.

A planar contact surface 2c is formed at the contact side at the opposite axial end of the sealing ring. In the cross section of the sealing ring in FIG. 1, the planar contact surface appears as a straight section radially extending in a direction perpendicular to axis A.

FIG. 1 shows an embodiment of a sealing ring of the invention in which the supporting section 2 is firmly connected to the sealing section 3. To this end a section is integrally formed on the other section. Either the sealing section is integrally formed on the supporting section 2 or the supporting section 2 on the sealing section 3. Preferably, the supporting section 2 is injected into the sealing section 3.

FIG. 2 shows a further embodiment of a sealing ring of the invention, wherein the supporting section 2 is not firmly connected to the sealing section 3. The contours of the supporting section 2 and of the sealing section 3 are precisely matched to one another at the contact points 2d and 3b for receiving the respectively other section, so that the supporting section 2 can be matingly connected to the sealing section 3.

FIG. 3 shows a further embodiment of a sealing ring of the invention, wherein the sealing ring is reinforced with a spring ring 4. The spring ring is here made from a spring strip that is first planar, as shown in FIG. 5. The spring strip is first re-shaped so that it has a U-profile in a direction perpendicular to the longitudinal axis in the cross-sectional view shown in FIG. 6. Finally, the free ends are welded with an overlap, resulting in a spring ring 4 with a U-shaped cross-section. In the embodiment, the spring ring 4 is coaxial to the sealing ring and has about the same average diameter. The spring ring 4 is entirely positioned within the supporting section 2 and is surrounded by the elastic material of the supporting section 2. The bent side of the spring ring 4 is oriented towards the front side of the sealing element 1 and the open side of the spring ring 4 opens towards the contact side. The bent side of the spring ring 4 extends substantially along the contact surface towards the sealing section 3 just below the surface 2d of the supporting section 2. The curvature of the spring ring 4 is here substantially identical with the curvature on the inside 3b of the sealing section 3. In the profile view of FIG. 3, the spring ring 4 seems to be U-shaped and the ring walls 4a and 4b seem to be legs of the same length that extend approximately up to the contact surface 2c without projecting beyond the contact surface 2c.

FIG. 4 essentially shows the preceding embodiment described with reference to FIG. 3. Due to the manufacturing process a free space 5 is created, starting from the plane of the contact surface 2c. Thus the contact surface 2c has an interruption.

Use and function of the sealing element of the invention shall now be explained with reference to the embodiment shown in FIG. 7.

The sealing element 1 has the purpose to seal at least two components 6, 7 relative to one another. To this end the sealing element 1 is arranged in the space between the two components 6, 7, the contact side 2c being placed at an axial end of the sealing ring on a contact surface 6a specifically provided for this purpose. The section 2a of the sealing element 1 is in contact with a section 6b of the component 6 and is thereby centered on the outside. However, it is also possible to provide a centering section on the inside 2b of the sealing element 1. At the side 2b which is opposite the radial contact side 2a, there is normally a clearance for permitting a radial expansion of the sealing ring 1 under compressive load.

For sealing purposes the sealing element 1 is at its front side 3a in contact with a further component 7 to be sealed. The arcuate surface 3a of the sealing section 3 touches a generally planar contact surface 7a of the component 7 to be sealed. The joint touch surface 3a/7a is relatively small and the surface pressure under compressive load in axial direction is correspondingly high at said place. This results in an excellent sealing effect.

At the contact side 2c, the sealing element is supported on another component 6 to be sealed. The contact surface 6a of the component 6 is here planar, just like the contact surface 2c. The compressive forces introduced by component 7 are transmitted via the sealing section 3 onto the elastic supporting section 2 and are introduced at the contact side 2c into the further component 6 to be sealed. The supporting section 2 is elastic according to the invention and compensates for irregularities of the support surface 6a under compressive load.

In the spring-reinforced embodiment, the spring ring 4 is arranged in the direction of the power flow through the sealing element 1. The spring curvature substantially corresponds to the curvature on the inside 3b of the sealing section 3, thereby absorbing the introduced force in an optimum way. The spring ring 4 extends substantially through the whole elastic supporting section 2 from the curved surface 2d, which is in contact with the inside 3b of the sealing section 3, up to the contact surface 2c. The spring action is achieved in that the side walls 4a and 4b of the spring ring 4 are supported at their free end on the contact surface 6a of the component. The spring ring 4 expands under compressive load, thereby pressing the sealing section 3 and the sealing surface 3a, respectively, against the contact surface 7a of the component 7. At the contact point, the contact pressure is very high due to the restoring effect of the spring ring 4, whereby an excellent sealing action is achieved.

The sealing ring 1 of the invention is also suited for sealing in radial direction. FIG. 8 shows an installation situation of the sealing ring 1 shown in FIG. 3, which is arranged in a biased state between a shaft 8 and a housing part 9 in a groove 9a. The sealing ring 1 has a clearance at its front side 3a and at the opposite side 2c to expand axially under bias. The sealing ring 1 is biased such that the whole contact surface 2b and a section of the sealing surface 3a rest on the peripheral surface 8a of the shaft 8. The whole contact surface 2a and a section of the sealing surface 3a are also in contact at the radial contact side 9b of groove 9a. Spring 4 produces a force counteracting the radial bias, thereby ensuring a high contact pressure on the contact surfaces 2a, 2b and 3a in radial direction.

A liquid (e.g. fuel) flowing through the gap 10 between the shaft 8 and the housing part 9 impinges in the sealing gap on the sealing surface 3a. According to the invention, the sealing section 3 is always oriented towards the side to be sealed, from which the medium (e.g. fuel) impinges on the sealing ring 1. The sealing section 3 consists of PTFE, a material that has a barrier effect with respect to hydrocarbons. Hence, a major part of the fuel is already retained by the sealing section 3. However, due to the surface roughness of the shaft 8, small channels are formed through which small leakage currents pass via the sealing section 3. The supporting section 2 follows the sealing section 3 in axial direction. After having passed through such a roughness channel in the sealing section 3, the leakage current impinges on the elastic material of the supporting section 2. Under the radial bias and supported by the spring 4, the soft elastomer of the supporting section 2 seals the remaining gaps along the roughness channels. Hence, the path of the leakage currents is obstructed and the shaft 8 is ideally sealed relative to the housing part 9.

1. A sealing element, preferably for sealing quick couplers of fuel lines, particularly in automotive vehicles, comprising a supporting section which is made at least in part from an elastic material, and a sealing section which is made from a material differing from the elastic material, the sealing element being provided on its circumference with at least one contact surface and at least one sealing surface, wherein at least one contact surface is formed by the supporting section and at least one sealing surface by the sealing section.

2. The sealing element according to claim 1, wherein a contact surface and a sealing surface are positioned at opposite sides of the sealing element.

3. The sealing element according to claim 1, wherein the supporting section is firmly connected to the sealing section.

4. The sealing element according to claim 1, wherein the supporting section is matingly connected to the sealing section.

5. The sealing element according to claim 1, wherein the sealing element is reinforced by a reinforcing means.

6. The sealing element according to claim 1, wherein the reinforcing means is formed by a spring means comprising at least one spring.

7. The sealing element according to claim 1, wherein the spring is positioned at least sectionwise within the supporting section.

8. The sealing element according to claim 1, wherein the spring is a bent spring strip.

9. The sealing element according to claim 1, wherein the spring substantially comprises a U-profile.

10. The sealing element according to claim 1, wherein the sealing section is made at least in part from a fluorine-containing material.

11. The sealing element according to claim 1, wherein the sealing section is made at least in part from a plastic material.

12. The sealing element according to claim 1, wherein the sealing section is made at least in part from a polymer.

13. The sealing element according to claim 1, wherein the sealing section is made at least in part from polyethylene.

14. The sealing element according to claim 1, wherein the sealing section is made from PTFE, particularly TFM.

15. The sealing element according to claim 1, wherein the supporting section is made at least in part from an elastomer.

16. The sealing element according to claim 1, wherein the outer surface of the sealing element has at least one substantially arcuate section when viewed in cross section.

17. The sealing element according to claim 1, wherein the sealing surface is substantially positioned inside the arcuate section.

18. The sealing element according to claim 1, wherein the sealing section forms a sealing lip.

19. The sealing element according to claim 1, wherein the sealing element forms a sealing ring.

20. The sealing element according to claim 1, wherein the spring is a spring ring and is arranged coaxial to the sealing ring.

21. The sealing element according to claim 1, wherein the contact surface is formed at an axial end of the sealing ring substantially in a direction perpendicular to the axis of the sealing ring.

22. The sealing element according to claim 1, wherein the sealing surface is formed at another axial end of the sealing ring opposite to the contact surface.

23. The sealing element according to claim 1, wherein a front side of the sealing ring is the sealing side at the same time.

24. The sealing element according to claim 1, wherein the sealing ring is provided in radial direction with at least one contact surface.

25. The sealing element according to claim 1, wherein the inner diameter of the sealing ring is preferably about 80-95%, preferably 90%, of the outer radius of the sealing ring.

26. The sealing element according to claim 1, wherein the sealing section occupies not more than 25% of the cross-sectional area of the sealing element.

27. The sealing element according to claim 1, wherein the sealing surface preferably covers 60-90%, preferably 75%, of the arc length of the arcuate section.

28. The sealing element according to claim 1, wherein the supporting section and the sealing section are flush with one another.

29. A method of producing a sealing element according to claim 1, wherein the supporting section and the sealing section are integrally formed on one another.

30. The method of producing a sealing element according to claim 1, wherein the supporting section is injected into the sealing section.
